(19) United States
(12) Patent Application Publication
(10) Pub. No.: US 2019/0062226 A1
(43) Pub. Date: Feb. 28, 2019

(54) DECORATIVE PRODUCT INCLUDING SOLUBLE PACKAGED BLEACH FOR INHIBITING SPOILAGE

(71) Applicant: UNITED STATES GYPSUM COMPANY, Chicago, IL (US)

(72) Inventors: Samar Emami, Chicago, IL (US); Jeffrey F. Grussing, Trevor, WI (US); Nancy L. Bernicke-Grussing, Trevor, WI (US); Salvatore C. Immordino, Trevor, WI (US); Nabin Kaini, Des Plaines, IL (US); Alexander J. Donovan, Lake Forest, IL (US)

(21) Appl. No.: 16/050,351

(22) Filed: Jul. 31, 2018

Related U.S. Application Data
(60) Provisional application No. 62/551,606, filed on Aug. 29, 2017.

(51) Int. Cl. C04B 41/45; C04B 41/50; B65D 65/46; B65D 85/00

(52) U.S. Cl. CPC C04B 41/4543; C04B 41/501; C04B 2111/0062; B65D 65/46; B65D 85/70; C04B 41/502

(57) ABSTRACT

A water-soluble texture enhancing composition, including a base powdered composition including powdered calcium carbonate, and a soluble packaged bleach, provided in sufficient quantity so that upon mixing with the base composition and water to form an aqueous slurry, and being agitated, the bleach provides an anti-microbial function for an extended period, preferably up to 80 hours. Also, a process for preparing a textured composition is provided, including providing a base powdered texture composition, providing soluble packaged bleach and mixing same with the base composition, and adding water to create an aqueous slurry, the soluble packaged bleach being provided in sufficient amount for inhibiting microbial growth in the solution for an extended period, preferably up to 80 hours.

### RELATED APPLICATION

This application claims 35 USC 119 priority from U.S. Provisional Patent Application No. 62/551,606 filed Aug. 29, 2017, which is incorporated by reference.

### BACKGROUND

The present invention relates generally to texture products designed for application upon wallboard panels creating walls and/or ceilings, and more specifically to such compositions for enhancing the composition shelf life after mixing with water through microbial and/or fungal control.

A common problem of installers of interior building construction materials is that mixtures of cellulose, water, starch and/or sugar, components of many common building materials and coatings used in interior construction, are prone to unwanted microbial and/or fungal growth. Such unwanted growth takes the form of bacteria, fungi or the like. In the context of the present application, the use of “microbial” will be understood to encompass all such organisms.

Paper and paperboard, including face and backing paper of wallboard panels have been observed as providing growth sites for various microorganisms. It is believed that the moisture content in the paper and other building materials is sufficient for maintaining the growth of these unwanted organisms, and the cellulose in the paper products, as well as the starch used commonly as a binder provides a needed microbial food supply. Most microorganisms can grow in temperatures ranging from 40-130° F., indoor as well as outdoor conditions do not inhibit microbial growth. In indoor construction, the face and backing paper of gypsum wallboard panels has been noted as a source for microbial growth, due to the presence of moisture and a cellulosic food supply.

Another property of conventional gypsum wallboard, as well as any porous building product or coating, is the susceptibility for absorbing moisture, which in many cases enhances microbial growth. While modern interior construction techniques promote isolation of gypsum wallboard and related coatings from sources of moisture, there is still potential for exposure to water through seepage, leaky roofs or pipes, condensation, as well as flooding caused by outside factors or defects unrelated to the wallboard itself.

Another common interior construction product relates to formulations used for creating decorative textures on walls or ceilings. Most conventional decorative texture products are provided in powder form, usually packaged in bags. When mixed with water at or near a jobsite and applied, either by spray or using manual techniques, the products create a texture to interior surfaces, including walls and ceilings. Among others, textures available through spray application include spatter, spatter knockdown and orange peel. Manually-applied textures include stipple, roller, Santa Fe, skip trowel, sea sponge, rag roller and others. In some cases, the manual techniques may be performed upon spray-applied texture compositions for obtaining desired visual effects. Regardless of the application technique, decorative textures are customarily painted after they dry.

A problem with such decorative texture products, regardless of whether they are applied by spray or manually, is that the applicator often has extra mix in his spray system at the end of a workday. The excess product is too expensive to dispose of at the jobsite, so it is often retained in the spray system, or in other containers when the product is applied manually. Since the base mixture has large amounts of water, starch, cellulose, and other ingredients that promote microbial growth, if the aqueous slurry is left for long periods, over a weekend or even overnight, the growth of unwanted microbes, including mold, other fungi and bacteria results in product that is visibly spoiled and/or smells unpleasant upon application. In some cases, the problems occur because the applicators do not adequately clean, flush and disinfect their spray equipment per manufacturer guidelines. Once the texture is dry on the surface, the problems due to microbial growth diminish significantly.

Prior attempts to reduce or remove the microbial growth or prevent spoilage involved the mixing of biocides into the decorative texture composition. Commonly-used biocides include fungicides and bactericides. However, even when such products were introduced at very low concentrations, in some cases, the applicators complained of unpleasant working conditions. In other cases, environmental regulations have discouraged or eliminated such biocides from indoor applications, especially spray applications. Other conventional techniques for inhibiting microbial growth on building surfaces include mixing such anti-microbial agents into the slurry formulation or the face paper. In some cases, the anti-microbial agents have been seen to cause adverse reactions to either applicators or inhabitants of the resulting space. Thus, the amount of biocide actually incorporated into the conventional texture compositions has been found to be inadequate to inhibit microbial growth when the texture composition is stored for extended periods as an aqueous slurry. Also, the amount of conventional biocides cannot be increased in the composition due to environmental regulations.

Thus, there is a need for an improved texture composition that has a longer in-tank or in-container shelf life once mixed, and which inhibits microbial growth for extended periods post-mixing.

### SUMMARY

The above-listed needs are met or exceeded by the present composition, including a standard ornamental wall or ceiling texture product, which is enhanced by the addition of bleach, preferably in water-soluble packets or packages. In other words, the present composition is a powdered, decorative sprayable product including bleach for inhibiting microbial growth for extended periods post-mixing as an aqueous slurry. In one embodiment, the soluble packaged bleach is incorporated into the aqueous slurry by the applicator on demand, such as at the end of a work day, when there is excess slurry available to be applied at a later time. It is also contemplated to add the bleach as a powder to the original texture product, or to provide the bleach in powdered format in a separate container for the applicator to incorporate as needed into the texture mixture. The present composition is contemplated as preventing microbial growth for up to 80 hours after mixing.

For the purposes of this application, “bleach” is defined as a water soluble compound, typically a chlorine-containing or oxidizing agent, that functions as a disinfectant upon dissolution or mixing with water. Suitable examples include the chlorine-containing agents, such as sodium hypochlorite and calcium hypochlorite, that exert their bacteriocidal effects by yielding hypochlorous acid in solution. A preferred bleach is sodium dichloroisocyanurate. Other known bleaches or bleaching agents include alkaline hypochlorites, hydrogen peroxide, and peroxyen compounds, all of which are also contemplated as being suitable, depending on the application. Upon mixing of the dry ingredients of the present texture composition, as well as the bleach packets in water, and optionally as mixing and/or agitation is enhanced through the use of a powered mixer, the packet or package will dissolve and the bleach will mix with the texture composition prior to application on the wall or ceiling. In the alternative, the bleach packets are contemplated as being added to an existing aqueous slurry of decorative texture composition for the purposes of inhibiting microbial growth over an extended storage period, such as over a weekend or holiday. The bleach will dissolve into the aqueous slurry, inhibiting microbial growth, especially when the slurry is left for extended periods in storage tanks or spray equipment. The resulting slurry will inhibit the growth of microbes and alleviate the potential spoilage problems identified above.

It is also contemplated in another embodiment that the solid, powdered bleach be added together with the other dry ingredients during the manufacturing process. Upon mixing of the decorative texture product containing the solid bleach in a mixer with water to form the texture slurry, the said solid bleach dissolves to provide the desired antimicrobial effect.

In addition, the present decorative texture solution incorporating bleach will disinfect previously contaminated mix and as well as related containers, including spray equipment. As alternatives to soluble packets, it is also contemplated that the bleach is formulated in soluble rigid capsules, tablets, or is packaged in thin films or soluble organic wrappers such as polyvinyl alcohol (PVOH). It is also contemplated that the bleach is preferably provided in powdered form, but is also contemplated as being provided in liquid format in a formulation that is compatible with the soluble packaging.

More specifically, the present invention provides a water-soluble texture enhancing composition, including a base powdered composition including powdered calcium carbonate, and a bleach, provided in sufficient quantity so that upon mixing with the base composition and water to form an aqueous slurry, and being agitated, the bleach provides an anti-microbial function for an extended period, preferably up to 80 hours.

In the preferred embodiment, the bleach is enclosed in a soluble package, and still preferably, the package is made of polyvinyl alcohol. It is also preferred that the bleach is provided as a soluble capsule.

In another embodiment, a process for preparing a textured composition is provided, including providing a base powdered texture composition, providing bleach and mixing same with the base composition, and adding water to create an aqueous slurry, the bleach being provided in sufficient amount for inhibiting microbial growth in the solution for an extended period, preferably up to 80 hours.

In another embodiment, the preferred bleach is sodium dichloroisocyanurate. In a preferred embodiment the bleach is provided in the range of 0.22 g-0.44 g/1000 g (dry basis) of the base powdered composition. In the most preferred embodiment, the bleach is provided in the range of 0.22-0.30 g/1,000 g dry basis of the base powdered composition. Also, it is preferred that the anti-microbial function extends for 7 days.

### DETAILED DESCRIPTION

The present composition is a powdered, water-soluble texture enhancing composition including a base powdered composition including powdered calcium carbonate. Such compositions are commonly available from United States Gypsum Company under the product designations SHEETROCK® Wall and Ceiling Texture, SHEETROCK® Ceiling Spray Texture QT and other similar products, which are powdered formulations preferably including calcium carbonate as a main ingredient, along with other additives, as are well known in the art. The base composition has a dry bulk density of 43.0-48.0 lb./ft³ (689-769 kg/m³), and a pH in the range of 7.0-10.0. In its commercial embodiment, the base composition is preferably provided in 40 and 50 lb bags (18.1 and 22.7 kg, respectively). It is contemplated that the size of the bag may vary to suit the application, for example 32 lb. (14.5 kg) bags are also known.

Upon application the base composition is an aggregated or unaggregated texture coating designed for application over most properly prepared interior surfaces, including ceilings or walls. When properly applied by spraying, manually, or by a combination of such techniques, the base composition produces a variety of texture patterns from bold spatter/knock-down to light orange peel. After application by hand, as by rolling, troweling or brushing, or by machine, such as spraying, the base composition dries to a hard white finish and helps conceal minor substrate defects. It is contemplated that the base composition is not a final coating, but instead is preferably overpainted when dry.

In addition to the base composition, a major feature of the present invention is the inclusion of bleach, provided in sufficient quantity so that upon mixing with the base composition and water to form an aqueous slurry, and being agitated, the bleach provides an anti-microbial function. A sufficient quantity of bleach is provided so that the anti-microbial function is effective for an extended period of time, preferably up to 80 hours. It is preferred that the bleach is in powdered form and is enclosed in a soluble package within the same container as the base composition, or provided in separate but closely associated packaging, so that the user obtains a satisfactory supply of bleach with the base composition. It is especially preferred that the bleach is provided in tablet form. For the purposes of this application, tablet form will be understood to be a type of soluble package. In another instance, the dry powdered bleach is comingled with the other dry ingredients of the texture product during the manufacturing process. After the end user mixes the dry ingredients, containing the bleach, with the requisite amount of water to form the texture slurry, the bleach begins to exert its biocidal effect

Any suitable soluble organic material is contemplated for packaging the present bleach formulation, such as a layer of polyvinyl alcohol (PVOH) or a thin film. It is also contemplated that the bleach is provided as a soluble capsule, or even in a liquid solution, provided that the soluble packaging material is compatible with the liquid bleach and the base composition and is not dissolved until mixed with water.

In use, employing a clean vessel, preferably equipped with a powered agitator, a portion of the base composition is stirred into a recommended amount of water, under agitation by a power mixer. The base composition is gradually added so that all of the composition is evenly mixed into the water. Either before, during or after mixing, the bleach is added, typically by dropping the packaged bleach into the aqueous slurry. The slurry is agitated until the soluble package is dissolved and the bleach is fully mixed into the slurry. After adding the base composition and the bleach to the water, the slurry is allowed to soak for at least 15 minutes, and remix until a creamy, lump-free mix is obtained. Excessive water in the slurry is to be avoided.

Since a popular application technique of such textures is spraying, the resulting spray consistency is achieved by adjusting the amount of base composition and/or water. Over thinning should be avoided. It is also contemplated that the bleach is added to the previously mixed decorative slurry, such as by the applicator upon conclusion of a work day and prior to storage of a remainder of the decorative slurry for an extended period, such as over a weekend or holiday. By not including the bleach in the base composition, the overuse of anti-microbial agents in the environment is reduced, while at the same time reducing waste of excess texture composition that can be used at a later time once mixed into an aqueous slurry.

An important feature of the present composition is the provision of the bleach in separately packaged format. In prior applications, the operator typically mixes a batch of the texture composition with water to form a slurry, and adds it to the spray equipment. However, depending on the size of the job and the speed of the applicator, there is likely a significant supply of aqueous slurry left over after the job, or at the end of a work day. To conserve resources, the applicator typically packages or otherwise stores the prepared mixed slurry until the next work session. However, due to the wide distribution of microbes, and the presence of the required elements for the life of such creatures, including food in the form of starch and other cellulosic additives, as well as the water making up the aqueous slurry, it is common for the operator to encounter a smelly, microbe-infested slurry by the next work session.

By providing the present bleach component, the growth of microbes is inhibited, and the user is able to reuse the excess mixed slurry of texture composition, thus reducing waste. Local authorities, and/or the U.S. Environmental Protection Agency restrict or prohibit dumping of excess texture slurry. In addition, after application, the cleaning and disinfecting of the operator's spray equipment, required by local authorities in many jurisdictions, is made easier by the incorporation of the present bleach powder into the base composition. It is considered a significant feature of the present composition that the anti-microbial action of the bleach is only temporary, and is intended to preserve the mixed texture composition for an extended but only a relatively short period of time, such as over a weekend or holiday, and then the microbial action dissipates.

Using suitable spray equipment, the present solution of base composition and bleach is applied by machine to create the desired effect. Potential effects from spray application include orange peel, spatter and spatter/knockdown, as is known in the art. The type of spray equipment may vary to suit the application, however for high production, either a piston pump or a rotor stator pump attached to a compressor or adequate size is recommended, as is a spray gun with a fan cap nozzle. Alternately, the present solution of base composition and bleach is applied manually for effects including stipple, roller, Santa Fe, skip trowel, sea sponge and rag roller. A minimal 55° F. (13° C.) temperature is desired in the room to promote proper drying. After the applied texture has dried, it should be promptly overpainted. If unpainted, the surface is not washable.

### Test Results:

Sterility Testing

Tests were conducted to determine the anti-microbial effectiveness over time of a single packet of bleach formulation, when mixed with a conventional, nutrient-containing texture composition. The selected texture composition was a standard formulation of USG SHEETROCK® Tuf-Tex Texture composition, which was also used as the Control.

The present invention was embodied in an amount of 0.22 g/1000 g dry basis of sodium dichloroisocyanurate bleach of the Control Composition, which is the equivalent to a single bleach packet per 50 lb bag of dry Control Composition. The treated (including bleach) composition was tested as a ready-to-spray slurry, at a spray viscosity of 200 Brabender Units (B.U.). Microbial growth was tested by providing standard Petri dishes (plates), each having one of two growth media: Tryptic Soy Agar (TSA) used for measuring bacterial growth, and Potato Dextrose Agar (PDA) used for measuring fungal growth, as is well known in the art. A plurality of plates of each media were daubed with either the Control Composition as formulated for application upon walls, or the Treated Composition, which was the Control Composition also having the 0.22 g/1000 g of bleach as described above. As time passed, the emergence of bacterial or fungal colonies were observed and counted. A measurement scale was developed as follows:

### Rating: 1 <10 Colonies

2 <11-39 Colonies

3 <40-100 Colonies

4 >100 Colonies.

It should be noted that the above Rating Scale is semi-logarithmic, so the difference between the listed Rating levels is quite significant.

As seen in Table 1 above, almost immediately, on Day 0, the Control exhibited colony growth on both the TSA and PDA plates. However, the Treated plates had no bacterial growth on the TSA plates on Day 1, while the PDA plates had a rating of 1 at Day 0. It is expected that initially, even with the Treated plates, some microbial activity will be observed, since there is a certain time lag for the effectiveness of the bleach.

TABLE 1
Sterility Testing:
Media: TSA & PDA Plates

| Description | TSA Plates | PDA Plates |
|---|---|---|
| Day 0 | | |
| Tuf Tex Control | 1 | 1 |
| Tuf-Tex Bleach 0.22 g | 0 | 1 |
| Day 10 | | |
| Tuf-Tex Control | 0 | 4 |
| Tuf-Tex Bleach 0.22 g | 0 | 0 |
| | | Bacteria growth |

TSA = Tryptic Soy Agar
PDA = Potato Dextrose Agar
1 <10 Colonies
2 11-39 Colonies
3 40-100 Colonies
4 >100 Colonies
*Items in “( )” mean organism count and <1 rating

At Day 10, within a commercially-viable time for use of the unused and stored texture composition, the Control had a rating of 0 on the TSA Plates and 4 on the PDA Plates, while the Treated plates of both media saw no microbial growth, indicating that the treatment was effective. The conclusion is that 1 bleach packet appears slightly more effective at prolonging preservation. While two bleach packets are considered to be clearly superior in reducing microbial growth, such a concentration of bleach is considered unsuitable to many applicators for creating an unpleasant working environment.

TABLE 1A
Two bleach packets
Table 1A: Two bleach packets

| Description | TSA Plates | PDA Plates |
|---|---|---|
| Jax Tuf Tex control | 0 | 4 |
| Jax Tuf Tex w/bleach | 0 | 0 |
| 7 days | | |
| Jax Tuf Tex control | 4 | 4 |
| Jax Tuf Tex w/bleach | 0 | 0 |

While two bleach packets are considered to be clearly superior in reducing microbial growth, such a concentration of bleach is considered unsuitable to many applicators for creating an unpleasant working environment.

In-Can Challenge (Inoculation) Tests

In these tests, the same SHEETROCK® Tuf-Tex texture composition of the above-described tests was again employed as the Control Composition. However, the Treated Composition was modified, in that the amount of sodium dichloroisocyanurate bleach was increased to 0.30 g/1000 g dry basis of the Control Texture Composition. Again, this represents a dosage of one packet per 50 lb. bag of texture composition. The additional bleach was provided to enhance performance, and was obtained by opening commercially-available bleach packets (CHLOROX CONTROL BLEACH PACKS® and measuring out additional amounts of bleach powder. It is contemplated that the bleach is provided in the range of 0.22-0.44 g/1,000 g dry basis of the base powdered composition. The bleach was added to the Tuf-Tex Control Composition, and the combined powder was then mixed with water.

Both the Control and the Treatment compositions were individually added to designated TSA plates. Next, the TSA plates were inoculated with various bacterial colonies of P. aeruginosa, B. subtilis, E. aerogenes and E. coli. These species were selected due to the presumption that they are the kinds of cultures most often growing in construction materials. Bacterial inoculation was at two concentrations, 0.25 ml and 0.50 ml of inoculum. After inoculation with the bacteria, the TSA plates were allowed to sit under observation. As colonies appeared, the same 1-4 Scale applied above was used to evaluate the performance of the treated texture composition.

TABLE 2
In-Can Resistance-TSA platings
Media: TSA
Inoculum: P. aeruginosa, B subtilis, E. aerogenes, E. coli

| | | | 24 | 48 | 7 | 48 HR |
|---|---|---|---|---|---|---|
| Bio | | Sterility | Hours | Hours | Days | (re) |
| Code | Description | Rating | Rating | Rating | Rating | Rating |
| | 0.25 ml inoculum | | | | | |
| B236 | Jax Tuf-Tex Control | 0 | 2 | 2 | 2 | 3-4 |
| B237 | Jax Tuf-Tex Bleach | 0 | 2 | 1 | 1 | 3 |
| | 0.50 ml inoculum | | | | | |
| B236- | Jax Tuf-Tex Control | 0 | 1-2 | 2 | 3 | 4 |
| 1 | | | | | | |
| B237- | Jax Tuf-Tex Bleach | 0 | 2 | 1 | 1 | 2 |
| 1 | | | | | | |

Reviewing Table 2 above, it will be seen that the Control Composition at both 0.25 ml and 0.50 ml inoculation levels, showed a consistent colony count of at least 2, except at the 24 Hour mark, where the rating was 1-2. However, aside from the 24 Hour mark, and the 48 Hr re-inoculation column, where greater colony growth is expected, the treated plates showed a much lower score of 1, noting that the sale is semi-logarithmic. In the last column, after 48 hours, the plates were re-inoculated with additional bacteria. In conclusion, a single bleach packet appears slightly more effective at prolonging shelf-life and preventing bacterial growth after inoculation. Note also that the anti-microbial function of the Treated Composition lasted 7 days.

While a particular embodiment of the present powdered decorative product including a packaged bleach for inhibiting spoilage has been described herein, it will be appreciated by those skilled in the art that changes and modifications may be made thereto without departing from the invention in its broader aspects and as set forth in the following claims.

1. A water-soluble texture enhancing composition, comprising:
a base powdered composition including powdered calcium carbonate; and
a soluble packaged bleach, provided in sufficient quantity so that upon mixing with said base composition and water to form an aqueous slurry, and being agitated, said soluble packaged bleach provides an anti-microbial function for an extended period, preferably up to 80 hours.

2. The composition of claim 1, wherein said package is soluble upon exposure to water.

3. The composition of claim 2, wherein said package is made of polyvinyl alcohol.

4. The composition of claim 2, wherein said bleach is provided as a soluble capsule.

5. The composition of claim 2, wherein said bleach is packaged in a thin film.

6. The composition of claim 1, wherein said bleach is in a powdered formulation.

7. The composition of claim 1, wherein said bleach is sodium dichloroisocyanurate.

8. The composition of claim 1, wherein said bleach is provided in the range of 0.22-0.30 g/1,000 g dry basis of said base powdered composition.

9. The composition of claim 1, wherein said bleach is provided in the range of 0.22-0.44 g/1,000 g dry basis of said base powdered composition.

10. The composition of claim 1, wherein said anti-microbial function extends for 7 days.

11. A process for preparing a textured composition, comprising:
providing a base powdered texture composition;
providing bleach in a soluble package and mixing same with said base composition; and
adding water to create an aqueous slurry, said soluble bleach being provided in sufficient amount for inhibiting microbial growth in said slurry for an extended period, preferably up to 80 hours.

12. The process of claim 11, wherein said bleach package is made of a soluble material so that the bleach is isolated from the base composition until the addition of the water.

13. The process of claim 11, wherein said bleach is provided in solid tablet form.

14. The process of claim 11, wherein said bleach is packaged in thin film.

15. The process of claim 11, wherein said bleach is in powdered form.

16. The process of claim 11, wherein said bleach is sodium dichloroisocyanurate.

17. The process of claim 11, wherein said bleach is provided in the range of 0.22-0.30 g/1,000 g dry basis of said base powdered composition.

18. The process of claim 11, wherein said bleach is provided in the range of 0.22-0.44 g/1,000 g dry basis of said base powdered composition.

19. A water-soluble texture enhancing composition, comprising:
a base powdered composition including powdered calcium carbonate; and
a bleach, provided in sufficient quantity and mixed with said base composition, so that upon mixing with water to form an aqueous slurry, and being agitated, said bleach provides an anti-microbial function for an extended period, preferably up to 80 hours.
